(19) United States
(12) Patent Application Publication
(10) Pub. No.: US 2024/0130285 A1
(43) Pub. Date: Apr. 25, 2024

(54) Maize Header For A Forage Harvester, And Forage Harvester Comprising Such A Maize Header

(71) Applicant: CLAAS Saulgau GmbH, 88348 Bad Saulgau (DE)

(72) Inventors: Josef Fischer, Biberach (DE); Felix Hafen, Salem (DE)

(21) Appl. No.: 18/488,669

(22) Filed: Oct. 16, 2023

(30) Foreign Application Priority Data
Oct. 23, 2022 (DE) 102022128070.5

(51) Int. Cl. A01D 43/08

(52) U.S. Cl. CPC A01D 43/082

(57) ABSTRACT

A maize header (2) comprising multiple mowing and infeed units (10) and comprising feeding drums (12) and turning drums (14, 15) arranged behind the mowing and infeed units (10), in the working position a feeding drum (12) is behind the two central mowing and infeed units (10a) and a first turning drum (14) is behind a transfer region between the central mowing and infeed units (10a) and a first lateral mowing and infeed unit (10b) that is laterally next to it, and to transfer the maize header (2) between the two positions, the mowing and infeed units (10) pivot relative to one another about axes (16) so the first lateral mowing and infeed units (10b) and one of the first turning drums (14) is pivotable relative to the adjoining central mowing and infeed unit (10a), so that, in the transport position, a frustoconical envelope (14a) of the respective first turning drum (14) is completely inside a permissible transport width of the maize header (2).

The invention relates to a maize header for a forage harvester according to the preamble of Claim 1. The invention also relates to a forage harvester comprising such a maize header.

In the case of harvesters, a distinction is fundamentally made between harvesters that thresh the crop, and harvesters that chop the crop. When a type of cereal, such as wheat, barley or oats, or rapeseed is intended to be harvested as crop, use is typically made of harvesters in the form of combine harvesters. By contrast, if maize, miscanthus or sorghum is intended to be harvested as crop, the harvesters used are typically forage harvesters.

A harvester which is in the form of a combine harvester and threshes a crop that is to be harvested has an attachment with multiple mowing members which harvest the crop by forming a scissors-like severing cut. By contrast, a harvester which is in the form of a forage harvester has an attachment which is in the form of a maize header and has multiple mowing members driven in revolution. The present invention here relates to a maize header of a harvester which is in the form of a forage harvester and chops, and accordingly does not thresh, the crop that is to be harvested.

DE 10 2004 022 534 A1 discloses a harvester which is in the form of a forage harvester and is intended for harvesting stalk crops, such as maize or the like. The harvester comprises a maize header, wherein the maize header comprises multiple mowing and infeed units with drum-like mowing and infeed members which are driven in revolution, can rotate substantially about a vertical axis of rotation and are intended for severing the crop in a substantially horizontal direction.

In DE 10 2004 022 534 A1, the mowing and infeed units of the maize header are pivotable in relation to one another in order to transfer the maize header between a working position and a transport position. In the working position, all the mowing and infeed units are arranged next to one another as seen transversely to the direction of travel or harvesting direction. In the transport position, the mowing and infeed units are arranged one above another in multiple planes.

There is a need for maize headers with increasingly great working widths. There is thus a need for maize headers which have a working width of up to 10.5 m or even up to 12 m. Such maize headers also must be transferable into a transport position which allows the maize header to be transported by road in a state coupled to the forage harvester. Thus, the transport width of a maize header should be no more than approximately 3.3 m for transport by road. Maize headers with increasing working widths cause difficulties in providing such a transport width. There is a need for a maize header which can be transferred into a transport position that enables transport by road while maintaining the permissible transport width even if the maize header has a large working width of, for example, up to 12 m.

Against this background, the present invention is based on the object of providing a novel maize header for a forage harvester, and a forage harvester comprising such a maize header.

This object is achieved by a maize header for a forage harvester according to Claim 1.

Feeding drums and turning drums which can be rotated about a vertical or approximately vertical axis are arranged behind the mowing and infeed units as seen in the harvesting direction, wherein, in the working position of the maize header, a respective feeding drum is arranged behind the two central mowing and infeed units as seen in the harvesting direction, and wherein, in the working position of the maize header, as seen in the harvesting direction, a respective first turning drum is arranged behind a transfer region between each of the central mowing and infeed units and a first lateral mowing and infeed unit that is arranged laterally directly next to it.

To transfer the maize header between the working position and a transport position, the mowing and infeed units are pivotable relative to one another about horizontal or approximately horizontal axes in such a way that each of the first lateral mowing and infeed units together with one of the first turning drums is pivotable relative to the respective adjoining central mowing and infeed unit, in such a way that, in the transport position, a frustoconical envelope of the respective first turning drum is completely inside a permissible transport width of the maize header in the transport position of the maize header.

In the case of the maize header according to the invention, turning drums are arranged behind the mowing and infeed units as seen in the harvesting direction and are displaced when the maize header is being transferred between the working position and the transport position together with those mowing and infeed units that can be displaced when the maize header is being transferred between the working position and the transport position.

These turning drums have a frustoconical envelope which lies completely inside a permissible transport width of the maize header in the transport position. Such frustoconically contoured turning drums make it possible to provide a transport width which enables transport by road with permissible transport dimensions even in the case of maize headers with a large working width of, for example, up to 12 m.

Preferably, the permissible transport width of the maize header is delimited by two vertically extending straight lines or planes, wherein a first one of the first turning drums in the transport position of the maize header adjoins a first one of the two vertically extending straight lines or planes and a second one of the first turning drums in the transport position of the maize header adjoins a second one of the two vertically extending straight lines or planes, in such a way that the frustoconical envelope of the respective first turning drum does not intersect the respective vertically extending straight line or plane. This is particularly preferred for maintaining the permissible transport width.

Preferably, a cone angle of the frustoconical envelope of the respective first turning drum is matched to a folding angle of the respective first lateral mowing and infeed unit in such a way that, in the transport position of the maize header, a laterally outer side or a laterally outer edge of the respective frustoconical envelope extends parallel or approximately parallel to the respective vertically extending straight line or plane. This is also particularly preferred for maintaining the permissible transport width of the maize header to enable transport by road.

Preferably, each of the two first turning drums is assigned a stripping member, which comprises multiple stripping guides and together with the respective first turning drum can be pivoted relative to the respective adjoining central mowing and infeed unit in such a way that, in the transport position, the stripping guides lie completely inside the permissible transport width of the maize header. To this end, it is preferably provided that, in the transport position of the maize header, a section in which lie edges of the respective stripping member that are situated opposite stripping edges of the stripping guides does not intersect the respective vertically extending straight line or plane. In particular, in the transport position of the maize header, the respective section extends parallel or approximately parallel to the respective vertically extending straight line or plane. This is also particularly preferred for maintaining the permissible transport width of the maize header to enable transport by road.

Preferably, in the working position of the maize header, as seen in the harvesting direction, a second turning drum is arranged behind a transfer region between each of the first lateral mowing and infeed units and a second lateral mowing and infeed unit arranged laterally next to it and is pivotable together with the respective second lateral mowing and infeed unit for transferring the maize header into the transport position. The two second turning drums in the transport position of the maize header are arranged on different sides of a vertically extending center line or center plane which extends centrally between the two straight lines or planes that define the permissible transport width of the maize header.

In the transport position of the maize header, a first one of the second turning drums adjoins the vertically extending center line or center plane on a first side and a second one of the second turning drums adjoins the vertically extending center line or center plane on a second side, in such a way that a frustoconical envelope of the respective second turning drum does not intersect the center straight line or center plane. This also serves to make it possible to transfer a maize header having a working width of, for example, up to 12 m into a compact transport position while maintaining a permissible transport width, in order to enable transport of the maize header by road in a state coupled to the forage harvester.

The forage harvester according to the invention is defined in Claim 13.

Preferred developments of the invention can be gathered from the dependent claims and the following description. Exemplary embodiments of the invention are explained in more detail, without being limited thereto, on the basis of the drawing, in which:

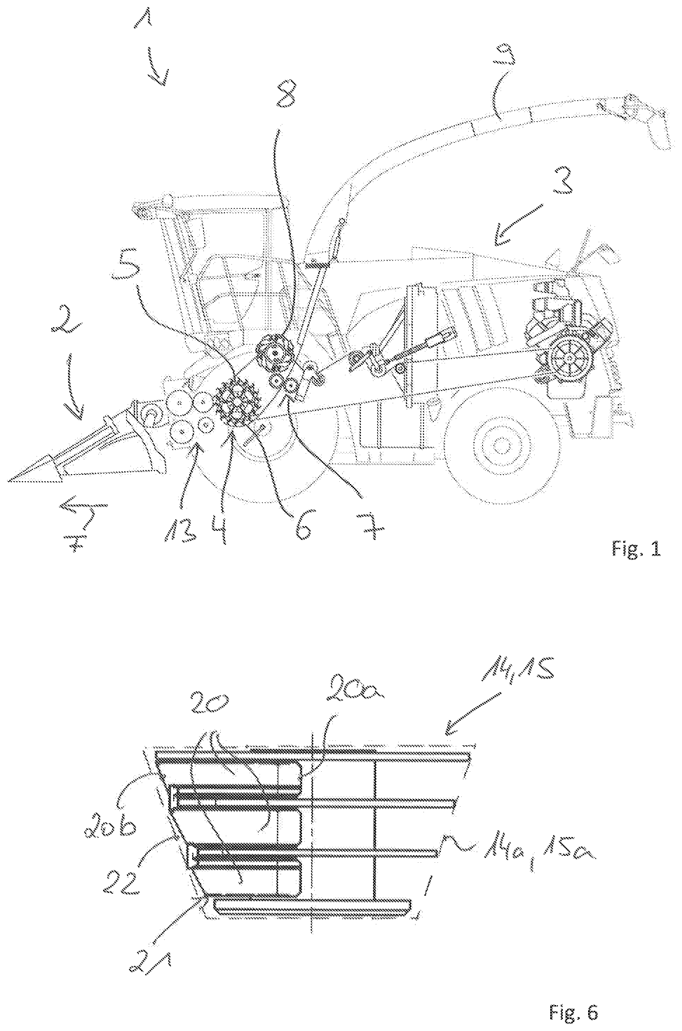

FIG. 1 shows a side view of a forage harvester comprising a maize header;

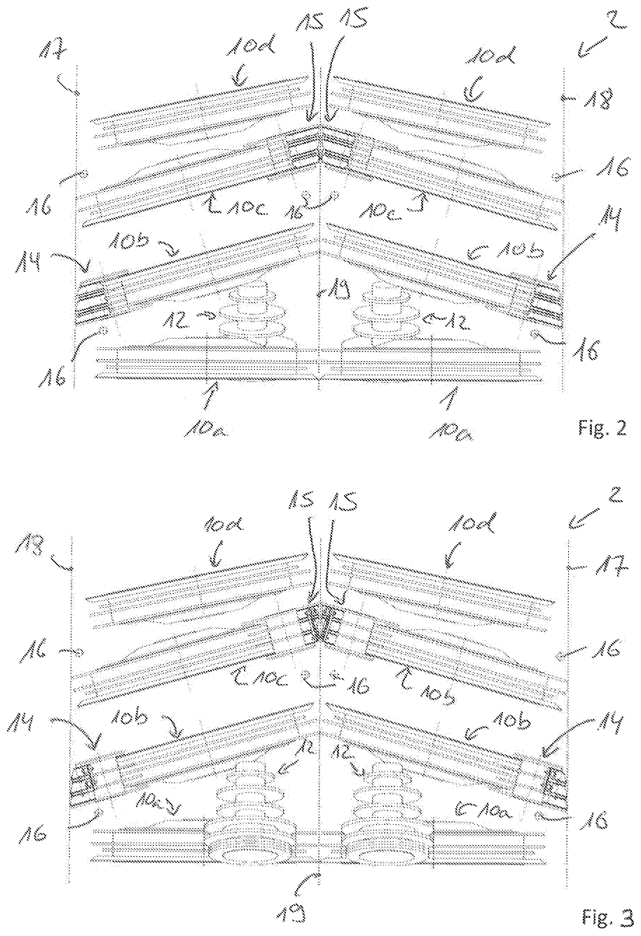

FIG. 2 shows a schematic view of assemblies of a maize header according to the invention in the transport position of the maize header, in a view counter to a direction of travel or harvesting direction of the forage harvester;

FIG. 3 shows a schematic view of assemblies of a maize header according to the invention in the transport position of the maize header, in a view in the direction of travel or harvesting direction of the forage harvester;

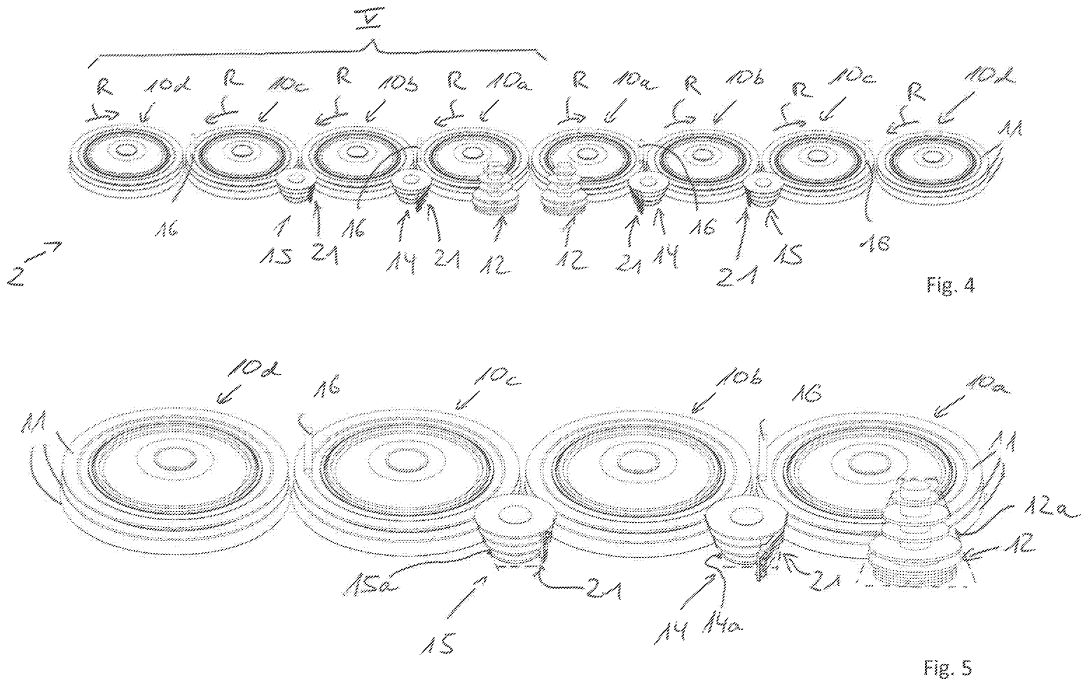

FIG. 4 shows a perspective plan view of assemblies of the maize header according to the invention in the working position of the maize header;

FIG. 5 shows the detail V in FIG. 4;

FIG. 6 shows a turning drum of the maize header according to the invention together with a stripping member assigned to the turning drum.

FIG. 1 shows a harvester in the form of a forage harvester 1. The forage harvester 1 comprises an attachment 2, which is coupled to a carrier vehicle 3 and is moved along by the carrier vehicle 3 in the direction of travel, which corresponds to the harvesting direction F, for harvesting work. The attachment 2 is what is referred to as a maize header for severing and taking up stalk crops, such as maize, miscanthus or sorghum.

The crop severed using the attachment 2 is moved inside the attachment through the attachment 2 and further processed by a chopping unit 4 of the forage harvester 1. The chopping unit 4 comprises a rotary chopping drum 5 and a drum base 6 arranged below the chopping drum 5.

Preferably, a conditioning device 7 is arranged downstream of the chopping unit 4 of the forage harvester 1 and a post-accelerator 8 is arranged downstream of the conditioning device 7. The conditioning device 7 is also referred to as grain cracker. The post-accelerator 8 serves in particular to introduce kinetic energy into the crop, in order to convey the crop through a discharge chute 9 with sufficient transporting speed.

The attachment 2, which is in the form of a maize header, of the forage harvester 1 has multiple mowing and infeed units 10, wherein each mowing and infeed unit 10 comprises multiple drum-like mowing and infeed members 11, which can be rotated about a vertical or approximately vertical axis and are driven in revolution. This rotation of the mowing and infeed units 10 about a respective vertical or approximately vertical axis takes place in the working position of the maize header 2. An approximately vertical axis extends substantially in the vertical direction and may be inclined with respect to the vertical direction, for example by 5° or 10°. The mowing and infeed members 11 of the maize header 2 that are driven in revolution serve to sever the crop in a substantially horizontal direction. The mowing and infeed members 11 of the maize header 2 are provided with conveying elements.

It should be pointed out at this juncture that the mowing and infeed members 11, that are driven in revolution, of the mowing and infeed units 10 of the maize header 2 may be in the form of chain-like mowing and infeed members 11.

Feeding drums 12, which convey the crop toward an infeed unit 13 of the forage harvester 1, are positioned downstream of central mowing and infeed units 10a of the maize header 2 as seen in the harvesting direction F. The feeding drums 12 are arranged behind the central mowing and infeed units 10 in the harvesting direction F and can be rotated about a vertical or approximately vertical axis. An approximately vertical axis extends substantially in the vertical direction and may be inclined or slanted with respect to the vertical direction.

In the working position of the maize header 2, a first lateral mowing and infeed unit 10b is arranged laterally next to a respective central mowing and infeed unit 10a, as can be seen best in FIG. 4. A respective first turning drum 14, which is rotatable about a vertical or approximately vertical axis, is arranged in a transfer region between each first lateral mowing and infeed unit 10b and the respective central mowing and infeed unit 10a. An approximately vertical axis extends substantially in the vertical direction and may be inclined or slanted with respect to the vertical direction, for example by 5° or 10°. In the working position, a respective second lateral mowing and infeed unit 10c adjoins the respective first lateral mowing and infeed unit 10b on the outside. A respective second turning drum 15 is arranged in a transfer region between the respective second lateral mowing and infeed unit 10c and the respective adjoining first lateral mowing and infeed unit 10b. The respective second turning drum 15 is rotatable about a vertical or approximately vertical axis. An approximately vertical axis extends substantially in the vertical direction and may be inclined or slanted with respect to the vertical direction, for example by 5° or 10°.

A third lateral mowing and infeed unit 10d then adjoins the respective second lateral mowing and infeed unit 10c on the outside. No turning drum is arranged in the transfer region between the respective second lateral mowing and infeed unit 10c and the respective third lateral mowing and infeed unit 10d owing to the direction of rotation of the mowing and infeed members, visualized by the arrows R in FIG. 4.

It can be seen in FIG. 4 that the respective third lateral mowing and infeed unit 10d rotates in the opposite direction to the adjoining second lateral mowing and infeed unit 10c. The respective second lateral mowing and infeed unit 10c rotates in the same direction as the adjoining first lateral mowing and infeed unit 10b and the respective adjoining central mowing and infeed unit 10a.

The mowing and infeed units 10 of the maize header 2 can be displaced from the working position of FIG. 4 to the transport position of FIGS. 2 and 3. FIGS. 2, 3 and 5 schematically show axes 16 about which the mowing and infeed units 10 can be displaced, that is to say pivoted or folded, relative to one another in the event of displacement between the working position and the transport position and vice versa, in the event of displacement between the transport position and the working position.

FIGS. 3 and 4 thus show that the respective first lateral mowing and infeed unit 10b is foldable or pivotable by approximately 160° relative to the respective adjoining and fixed central mowing and infeed unit 10a about an axis 16 extending in a horizontal or approximately horizontal direction. The respective second lateral mowing and infeed unit 10c is pivotable or foldable by approximately 180° relative to the adjacent respective first mowing and infeed unit 10b about a horizontal or approximately horizontal axis 16. Furthermore, the respective third lateral mowing and infeed unit 10d is also pivotable or foldable by approximately 180° relative to the respective adjoining second lateral mowing and infeed unit 10c about a horizontally or approximately horizontally extending axis 16. An approximately horizontal axis extends substantially in the horizontal direction and may be inclined or slanted with respect to the horizontal direction, for example by 5° or 10°.

According to FIGS. 2 and 3, the first turning drums 14 are pivotable or foldable together with the respective first lateral mowing and infeed units 10b and the second turning drums 15 are pivotable or foldable together with the respective second lateral mowing and infeed units 10c about the respective axes 16, specifically when the maize header is being transferred between the working position and the transport position.

FIGS. 2 and 3 depict a dimension of the maize header 2 in vertically extending straight lines or planes 17, 18 transversely to the harvesting direction F, wherein the distance between these planes or straight lines 17, 18 corresponds to the maximum permissible transport width of the maize header 2. A center line or center plane 19, which extends centrally between the two central mowing and infeed units 10a, is shown in the middle between these two straight lines or planes 17, 18.

As already stated, the mowing and infeed units 10 are displaceable or pivotable and thus foldable relative to one another about the axes 16 for transferring the maize header 2 between the working position and the transport position.

Each of the first lateral mowing and infeed units 10b is pivotable and thus foldable together with its assigned first turning drum 14 relative to the respective adjoining central mowing and infeed unit 10a, specifically in such a way that a frustoconical envelope 14a of the respective first turning drum 14 and thus the respective first turning drum 14 and thus the respective first turning drum 14 is completely inside the permissible transport width, defined by the vertically extending straight lines or planes 17, 18, of the maize header 2 in the transport position of the maize header 2 shown in FIGS. 2 and 3.

The envelope 14a of the first turning drums 14 is shown in FIG. 5, wherein this frustoconical envelope 14a tapers from top to bottom and accordingly widens from bottom to top in the working position of the maize header 2. The feeding drums 12 also have a frustoconical envelope 12a, although this envelope tapers from bottom to top and accordingly widens from top to bottom.

Furthermore, FIG. 5 shows that the second turning drums 15 also have a frustoconical contour, specifically in an orientation like the first turning drums 14, that is to say such that the envelope 15a of the second turning drums 15 tapers from top to bottom and accordingly widens from bottom to top in the working position of the maize header 2.

As can be seen best in FIGS. 2 and 3, in the transport position of the maize header 2, a first one of the first turning drums 14 adjoins a first one of the two vertically extending straight lines or planes 17 and a second one of the first turning drums 14 adjoins a second one of the two vertically extending straight lines or planes 18, specifically in such a way that the frustoconical envelope 14a of the respective first turning drum 14 does not intersect the respective vertically extending straight line or plane 17, 18.

To this end, a cone angle of the frustoconical envelope 14a of the respective first turning drum 14 is matched to a pivot angle or folding angle of the respective first lateral mowing and infeed unit 10b in such a way that, in the transport position of the maize header 2, a respective laterally outer side or a respective laterally outer edge of the respective frustoconical envelope 14a of the respective first turning drum 14 extends parallel or approximately parallel to the respective vertically extending straight line or plane 17, 18.

As already stated, to transfer the maize header from the working position to the transport position, the two turning drums 15 together with the second lateral mowing and infeed units 10c are pivotable or foldable about the respective axes 16 relative to the first lateral mowing and infeed units 10b.

According to FIGS. 2 and 3, in the transport position of the maize header 2, the two second turning drums 15 are arranged on different sides of the vertically extending center line or center plane 19, wherein, in the transport position of the maize header 2, a first one of the second turning drums 15 adjoins the vertically extending center line or center plane 19 on a first side and a second one of the second turning drums 15 adjoins the vertically extending center line or center plane on a second side, specifically in such a way that the frustoconical envelope 15a of the respective second turning drum 15 does not intersect the center line or center plane 19.

To this end, in that case in turn, a cone angle of the frustoconical envelope 15a of the respective second turning drum 15 is matched to the pivot angle or folding angle of the respective second outer mowing and infeed unit 10c in such a way that, in the transport position of the maize header 2, a laterally inner side or a laterally inner edge of the respective frustoconical envelope 15a of the respective second turning drum 15 extends parallel or approximately parallel to the respective center line or center plane 19 in the transport position of the maize header 2.

A stripping member 21 comprising multiple stripping guides 20 interacts with each of the two first turning drums 14. Such stripping members 21 are also assigned to the second turning drums 15. The stripping guides 20 can be deduced from the detail of FIG. 6, which shows a turning drum 14 or 15 together with a stripping member 21 assigned to it.

The stripping members 20 assigned to the turning drums 14, 15 are pivotable or foldable together with the respective turning drums 14, 15 when the maize header 2 is being transferred between the working position and the transport position.

The stripping members 21 assigned to the first turning drums 14 are accordingly pivotable or foldable, together with the first turning drums 14 and the first lateral mowing and infeed units 10b, relative to the central mowing and infeed units 10a. The stripping members 21 assigned to the second turning drums 15 are pivotable or foldable, together with the second turning drums 15 and the second lateral mowing and infeed units 10c, relative to the first lateral mowing and infeed units 10b.

In the transport position of the maize header 2, the stripping guides 20 of the stripping members 21 assigned to the first turning drums 14, and thus these stripping members 21, together with the first turning drums 14 lie completely inside the transport width, defined by the vertically extending straight lines or planes 17, 18, of the maize header 2.

The stripping guides 20 have stripping edges 20a and edges 20b situated opposite the stripping edges 20a, wherein a section 22 in which lie those edges 20b of the stripping guides 20 of the respective stripping member 21 that are situated opposite the stripping edges 20a does not intersect the respective vertically extending straight line or plane 17, 18 in the transport position of the maize header 2. Rather, as can be seen in FIGS. 2 and 3, this section 22 of the stripping members 21 assigned to the first turning drum 14, in which lie those edges 20b of the stripping guides 20 that are situated opposite the stripping edges 20a of the stripping guides 20, extends preferably parallel or approximately parallel to the respective vertically extending straight line or plane 17, 18, in particular congruently with that side of the frustoconical envelope 14a of the respective first turning drum 14 that is the respective laterally outer one in the transport position of the maize header 2.

As already stated, such stripping members 21 are also assigned to the second turning drums 15 and are pivotable together with the respective second lateral mowing and infeed unit 10c relative to the respective adjoining first lateral mowing and infeed unit 10b. In the transport position of the maize header 2, in that case the stripping guides 20 of the stripping member 21 assigned to the first one of the second turning drums 15 lie on the first side and the stripping guides 20 of the stripping member 21 assigned to the second one of the second turning drums 15 lie on the second side of the center line or center plane 19. The respective section 22 in which lie edges 20b of the respective stripping member 21 that are situated opposite the stripping edges 20a of the stripping guides 20 does not intersect the vertically extending center line or center plane 19, but extends preferably parallel to it, in particular congruently with the side that is the respective inner side in the transport position of the maize header or with the respective inner edge of the frustoconical envelope 15a of the respective second turning drum 15.

The above embodiment of the maize header 2 makes it possible to enable a compact transport position which allows transport of the maize header 2 by road in a state coupled to the carrier vehicle 3, even in the case of a maize header having a working width of, for example, up to 12 m.

The respective turning drums 14, 15 are pivotable or foldable together with the respective lateral mowing and infeed units 10b, 10c in the manner described above and have a frustoconical contour with a defined cone angle matched to a folding angle and thus pivot angle of the mowing and infeed units 10b, 10c in the manner described above. The same holds true for the stripping members 21 assigned to the turning drums 14, 15, the stripping members being matched in terms of the contour of their stripping guides 20, specifically the contour of the edges 20b of the stripping guides 20 that are situated opposite the stripping edges 20a, to the frustoconical contour of the envelopes 14a, 15a of the respective turning drum 14, 15 and thus to its cone angle and thus to the folding angle of the mowing and infeed units 10b, 10c.

### LIST OF REFERENCE SIGNS

1 Forage harvester
2 Attachment/Maize header
3 Carrier vehicle
4 Chopping unit
5 Chopping drum
6 Drum base
7 Conditioning device
8 Post-accelerator
9 Discharge chute
10 Mowing and infeed unit
10a Central mowing and infeed unit
10b First lateral mowing and infeed unit
10c Second lateral mowing and infeed unit
10d Third lateral mowing and infeed unit
11 Mowing and infeed member
12 Feeding drum
13 Infeed unit
14 Turning drum
14a Envelope
15 Turning drum
15a Envelope
16 Axis
17 Straight line/Plane
18 Straight line/Plane
19 Center line/Center plane
20 Stripping guide
20a Stripping edge
20b Edge
21 Stripping member
22 Section

1. A maize header (2) for a forage harvester (1) for harvesting stalk crops,
comprising multiple mowing and infeed units (10) each having multiple drum-like or chain-like mowing and infeed members (11) which can be rotated about a vertical or approximately vertical axis, can be driven in revolution, and are intended for severing the crop in a substantially horizontal direction from a field that is to be cultivated,
comprising feeding drums (12) and turning drums (14, 15) which are arranged behind the mowing and infeed units (10) as seen in the harvesting direction and can be rotated about a vertical or approximately vertical axis,
wherein, in the working position of the maize header (2), a respective feeding drum (12) is arranged behind the two central mowing and infeed units (10a) as seen in the harvesting direction,
wherein, in the working position of the maize header (2), as seen in the harvesting direction, a respective first turning drum (14) is arranged behind a transfer region between each of the central mowing and infeed units (10a) and a first lateral mowing and infeed unit (10b) that is arranged laterally directly next to it,
wherein, to transfer the maize header (2) between the working position and a transport position, the mowing and infeed units (10) are pivotable relative to one another about horizontal or approximately horizontal axes (16) in such a way that each of the first lateral mowing and infeed units (10b) together with one of the first turning drums (14) is pivotable relative to the respective adjoining central mowing and infeed unit (10a), in such a way that, in the transport position of the maize header (2), a frustoconical envelope (14a) of the respective first turning drum (14) is completely inside a permissible transport width of the maize header (2) in the transport position of the maize header (2).

2. The maize header (2) according to claim 1, characterized in that the permissible transport width of the maize header (2) is delimited by two vertically extending straight lines or planes (17, 18), wherein a first one of the first turning drums (14) in the transport position of the maize header (2) adjoins a first one of the two vertically extending straight lines or planes (17) and a second one of the first turning drums (14) in the transport position of the maize header (2) adjoins a second one of the two vertically extending straight lines or planes (18), in such a way that the frustoconical envelope (14a) of the respective first turning drum (14) does not intersect the respective vertically extending straight line or plane (17, 18).

3. The maize header (2) according to claim 2, characterized in that a cone angle of the frustoconical envelope (14a) of the respective first turning drum (14) is matched to a folding angle of the respective first lateral mowing and infeed unit (10b) in such a way that, in the transport position of the maize header (2), a laterally outer side or a laterally outer edge of the frustoconical envelope (14a) extends parallel or approximately parallel to the respective vertically extending straight line or plane (17, 18).

4. The maize header (2) according to claim 1, characterized in that each of the two first turning drums (14) is assigned a stripping member (21), which comprises multiple stripping guides (20) and together with the respective first turning drum (14) can be pivoted relative to the respective adjoining central mowing and infeed unit (10a), in such a way that, in the transport position, the stripping guides (20) lie completely inside the permissible transport width of the maize header (2).

5. The maize header (2) according to claim 4, characterized in that, in the transport position of the maize header (2), a section (22) in which edges (20b) of the respective stripping member (21) that are situated opposite stripping edges (20a) of the stripping guides (20) does not intersect the respective vertically extending straight line or plane (17, 18).

6. The maize header (2) according to claim 5, characterized in that, in the transport position of the maize header (2), the respective section (22) extends parallel or approximately parallel to the respective vertically extending straight line or plane (17, 18).

7. The maize header (2) according to claim 1, characterized in that, in the working position of the maize header (2), as seen in the harvesting direction, a second turning drum (15) is arranged behind a transfer region between each of the first lateral mowing and infeed units (10b) and a second lateral mowing and infeed unit (10c) arranged laterally next to it and is pivotable together with the respective second lateral mowing and infeed unit (10c) for transferring the maize header (2) into the transport position.

8. The maize header (2) according to claim 7, characterized in that
the two second turning drums (15) in the transport position of the maize header (2) are arranged on different sides of a vertically extending center line or center plane (19) which extends centrally between the two straight lines or planes (17, 18) that define the permissible transport width of the maize header,
in the transport position of the maize header (2), a first one of the second turning drums (15) adjoins the vertically extending center line or center plane (19) on a first side and a second one of the second turning drums (15) adjoins the vertically extending center line or center plane on a second side, in such a way that a frustoconical envelope (15a) of the respective second turning drum (15) does not intersect the center straight line or center plane (19).

9. The maize header (2) according to claim 8, characterized in that a cone angle of the frustoconical envelope (15a) of the respective second turning drum (15) is matched to a folding angle of the respective second outer mowing and infeed unit (10c) in such a way that, in the transport position of the maize header (2), a laterally inner side or a laterally inner edge of the frustoconical envelope (15a) extends parallel or approximately parallel to the respective center line or center plane.

10. The maize header (2) according to claim 7, characterized in that each of the two second turning drums (15) is assigned a stripping member (21), which comprises multiple stripping guides (20) and together with the respective second lateral mowing and infeed unit (10c) is pivotable relative to the respective adjoining first lateral mowing and infeed unit (10b), in such a way that, in the transport position of the maize header, the stripping guides (20) of the stripping member (21) assigned to the first one of the second turning drums (15) lie on the first side and the stripping guides of the stripping member (21) assigned to the second one of the second turning drums (15) lie on the second side of the center straight line or center plane (19).

11. The maize header (2) according to claim 10, characterized in that, in the transport position of the maize header (2), a section (22) in which edges (20b) of the respective stripping member (21) that are situated opposite stripping edges (20a) of the stripping guides (20) does not intersect the respective vertically extending center line or center plane.

12. The maize header (2) according to claim 11, characterized in that, in the transport position of the maize header (2), the respective section (22) extends parallel or approximately parallel to the center line or center plane (19).

13. A forage harvester (1) comprising a maize header (2) according to claim 1.
